(19) United States
(12) Patent Application Publication
(10) Pub. No.: US 2002/0038268 A1
(43) Pub. Date: Mar. 28, 2002

(54) Financial cost prediction system and method

(76) Inventors: Chiun-Kwei Yang, Taipei (TW); Hsiu-Lan Ting, Hsinchu (TW); Meng-Cheng Lai, Taichung Hsien (TW)

Correspondence Address: J.C. Patents, Inc., Suite114, 1340 Reynolds Ave., irvine, CA, 92614, US

(21) Appl. No.: 09/727,948

(22) Filed: Dec. 1, 2000

(30) Foreign Application Priority Data
Sep. 25, 2000 (TW) 89119719

(51) Int. Cl. G06F 17/60

(52) U.S. Cl. 705/30

(57) ABSTRACT

A financial cost prediction system method, wherein the subserver of each department is connected to the main server, and the initial cost data of each department is screened and classified via the main server to form financial reports. The financial reports and further organized into a standard cost account, and are provided to the finance department user terminal for to access the financial reports and to compare to the standard cost account. Also, the present system enables the initial cost data to automatically compile into financial reports and sets the schedules of the main server, so as to automatically correct erroneous financial reports. By using this system, to predict the cost and expense for the coming month or the coming year can be obtained.

### CROSS-REFERENCE TO RELATED APPLICATION

This application claims the priority benefit of Taiwan application serial no. 89119719, filed Sep. 25, 2000.

### BACKGROUND OF THE INVENTION

1. Field of the Invention

The present invention relates to a financial cost prediction system and method. More particularly, the present invention relates to a method and a system of organizing the initial cost data provided by each department into financial reports and standard cost account.

2. Description of the Related Art

In large-scale industry, since there are huge operations in every department, many problems arise during compilation of month-end or year-end financial reports. At month-end or year-end, each department will only further organize the initial cost data of the department into tables, whereupon the tables are sent to the finance department. The finance department must compare the initial cost data one by one, and provide the initial cost data required by the financial reports. The large quantities of data in the initial cost data will cause the finance department data to be misread or misinterpreted, thereby causing the data in the financial reports to be inaccurate. It is time- and resource-consuming for the finance department to investigate the problem areas since this entails reviewing the initial cost data anew in order to locate the errors, as well as recalculating and tallying up the initial cost data anew.

In summary, according to the above-described related art technique, although the financial reports can be compiled manually, however, there are many disadvantages:

1. The rate of numerical accuracy is very low.

2. The initial cost data in the related art is time-consuming as it must be manually selected to match the data in the financial reports and then further organized.

3. When there is an error in the financial reports, the finance department must again review the initial cost data, recalculate and tally up the initial cost data and is therefore, inefficient.

### SUMMARY OF THE INVENTION

In light of the above, the invention provides a financial cost prediction system and method, wherein the aim is to automatically screen and classify the initial cost data via this system for compilation into a financial report. Thus, the rate of numerical accuracy is raised, and the financial reports can be organized into a standard cost account, thereby facilitating the aim of estimating financial costs. Also, when there is a numerical error in the financial reports, the corrected data can be re-entered into the main server and a schedule can be set to create a new financial report, thus saving time and effort.

As embodied and broadly described herein, the invention provides a financial cost prediction system and method. The financial cost prediction system is related to compiling the initial cost data of a finance department into financial reports, organizing the financial reports into a standard cost account automated or window system. Each department sends the initial cost data to the subserver of each department, whereupon each subserver stores the initial cost data into the corresponding sub-database. When the main server must retrieve and organize the initial cost data, the screened and classified initial cost data is compiled into financial reports by the main server. The main server further organizes the financial reports into a standard cost account. If an error should occur in the standard cost account, the initial cost data in the financial reports will be checked for errors. If there is an error in the initial cost data, then the finance department user terminal will correct the erroneous financial report.

The present invention is made of core of a main server and a main database, wherein the initial cost data is screened and classified into financial reports via the main server and the main database. Thus, the finance department user terminal is provided with access to the financial tables, the financial tables can automatically adjust and can predict future financial costs, and can set the schedules to automatically correct erroneous financial reports.

It is to be understood that both the foregoing general description and the following detailed description are exemplary, and are intended to provide further explanation of the invention as claimed,

### BRIEF DESCRIPTION OF THE DRAWINGS

The accompanying drawings are included to provide a further understanding of the invention, and are incorporated in and constitute a part of this specification. The drawings illustrate embodiments of the invention, and, together with the description, serve to explain the principles of the invention. In the drawings,

FIG. 1 is a schematic diagram according to one preferred embodiment of the present invention; and

FIG. 2 is a flow diagram according to one preferred embodiment of this invention.

### DESCRIPTION OF THE PREFERRED EMBODIMENTS

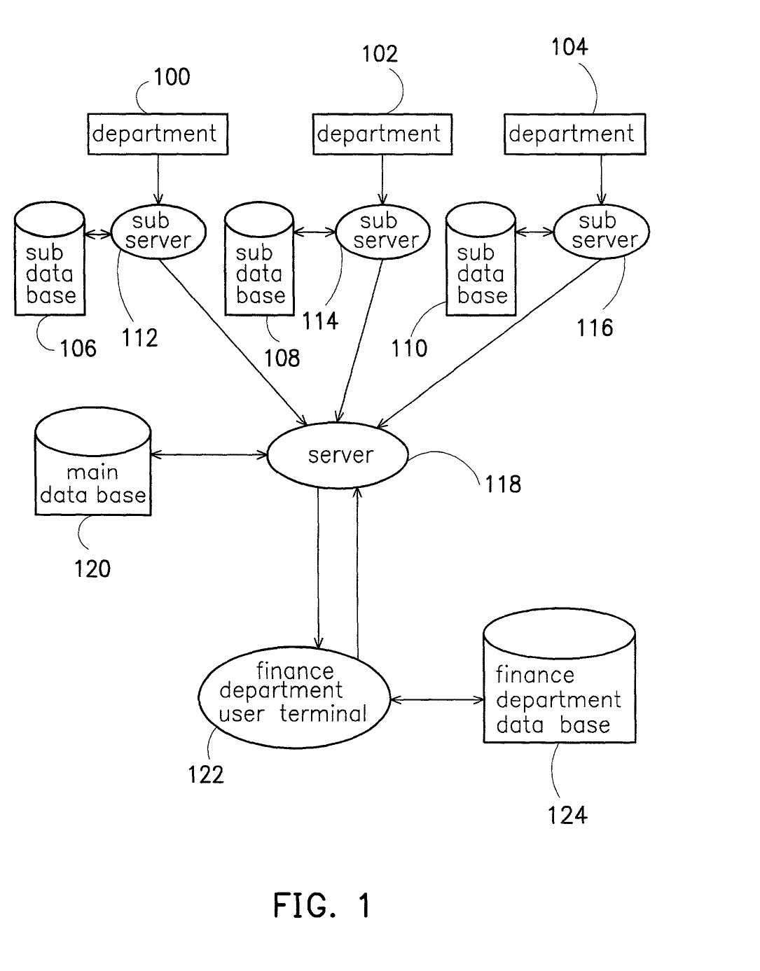

FIG. 1 is a schematic diagram according to one preferred embodiment of the present invention. The financial cost prediction system includes a plurality of subservers 112, 114 and 116, a plurality of databases 106, 108 and 110, main server 118, main database 120, finance department user terminal 122 and finance department database 124.

The plurality of subservers 112, 114 and 116 correspond to each of the departments 100, 102 and 104 respectively, and are used to receive the initial cost data sent from the departments 100, 102 and 104. The plurality of databases 106, 108 and 110 correspond to each of the subservers 112, 114 and 116 respectively, and are used to store the initial cost data sent by the subservers 112, 114 and 116. The main server 118 is connected to the subservers 112, 114 and 116 and receives the initial cost data from the subservers 112, 114 and 116. The main server 118 also organizes and compiles the initial cost data into a financial table, and further arranges the financial table into a standard cost account. The main database 120 is connected to the main server 118 and stores the initial cost data, the financial reports and the standard cost account are sent through the main server. The finance department database 124 is connected to the finance department user terminal 122 and is used to store the financial reports and the standard cost account sent from the department user terminal 122.

The departments 100, 102 and 104 send the initial cost data to each sub server 112, 114 and 116. The initial cost data sent by each of the departments 100, 102 and 104 includes the raw wafer quantities, raw wafer costs, production shelf life, discarded raw wafer costs, as well as project-testing costs and loaned equipment costs. The subservers 112, 114 and 116 store the initial cost data into the corresponding sub-databases 106, 108 and 110. The main server 118 will retrieve the initial cost data from the sub-databases 106, 108 and 110 corresponding to the subservers 112, 114 and 116. The main server 118 further organizes the initial cost data includes a process whereby the initial cost data is screened and classified. The main server 118 stores the screened and classified initial cost data into the corresponding main database 120. The main database 120 has a financial data generating zone where stores the initial cost data screened and classified by the main server 118. After the initial cost data has been screened and classified, the main server 118 compiles the screened and classified initial cost data into a financial report. The main server 118 compiles the initial cost data by a process such as by setting schedules of the main server. The initial cost data stored in the financial data generating zone is compiled into a financial report according to the schedules of the main server. The compiled financial reports include wafer financial reports, period-start/period-end financial reports, ENG financial reports, MOVE financial reports, Yield financial reports and Others financial reports. The wafer financial reports include summary reports based on raw wafer quantity, raw wafer cost and raw wafer total cost. The period-start/period-end financial reports further include initial production cost summary reports, end production cost summary reports and production shelf life detailed reports. ENG financial reports further include project-testing cost summary reports, loaned equipment cost summary reports and owner change cost detailed reports. The MOVE financial reports further include raw wafer summary reports, raw wafer cost analysis reports and heavy industry production cost detailed reports. Daily Move Check detailed reports and YIELD financial reports further include productivity difference detailed reports and discarded production cost summary reports. The Others financial reports further include production volume detailed reports, production cost detailed reports and production testing transfer cost summary reports. The main server 118 further organizes the financial reports into a standard cost account. When there is an error in the standard cost account, the initial cost account can be checked for errors and the finance department user terminal 122 will correct the erroneous financial reports. The correction process of the finance department user terminal 122 includes correcting the initial cost data that form the financial reports, and setting the schedules of the main server and compiling a new financial report.

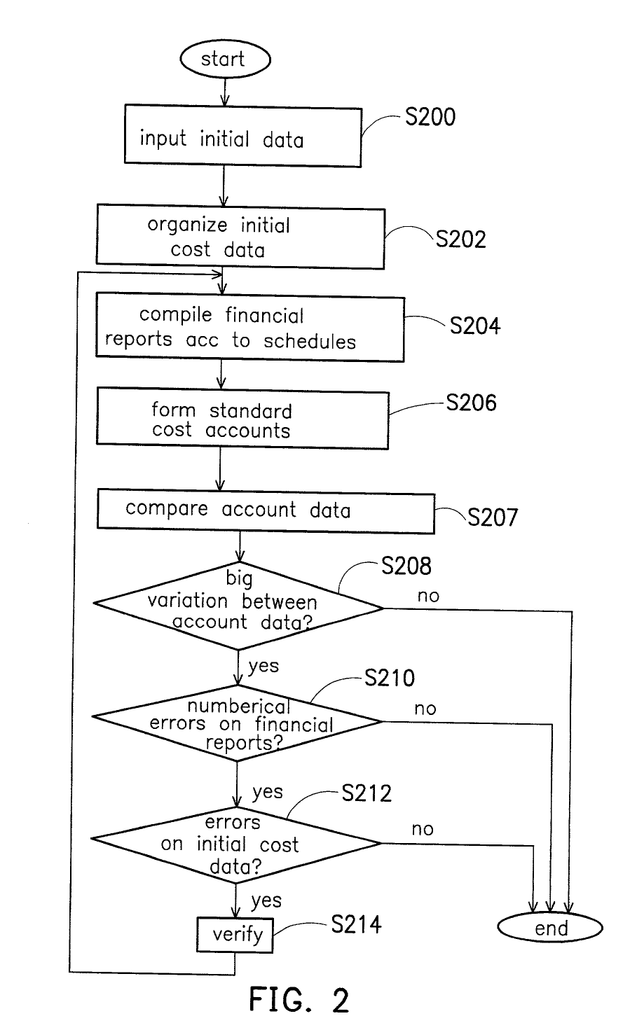

FIG. 2 is a flow diagram according to one preferred embodiment of this invention. The financial cost prediction method procedure includes inputting the initial cost data into the cost prediction system in the step s200. The inputted initial cost data includes raw wafer quantities, raw wafer costs, production shelf life, production discard costs, project-testing costs and loaned equipment costs. In step s202, the financial cost prediction system will organize the initial cost data. The procedures of organizing the initial cost data include screening and classifying the initial cost data, and storing the initial cost data thereafter. In step s204, the financial cost prediction system will compile a financial report based on the schedules. The compiled financial reports include wafer financial reports, period-start/period-end financial reports, ENG financial reports, MOVE financial reports, Yield financial reports and Others financial reports. The wafer financial reports include raw wafer quantity summary reports, raw wafer cost summary reports and raw wafer total cost summary reports. The period-start/period-end financial reports include initial production cost summary reports, production end cost summary reports and production shelf life detailed reports. ENG financial reports further include project-testing cost summary reports, loaned equipment cost summary reports and owner change cost detailed reports. MOVE financial reports further include raw wafer summary reports, production cost analysis reports and heavy production cost detailed reports. The Daily Move Check detailed reports and the Yield financial reports further include productivity difference detailed reports and production discard cost summary reports. Others financial reports further include production volume detailed reports, production cost detailed reports and production testing transfer cost summary report. In step s206, the financial cost prediction system organizes the financial reports into a standard cost account. In step s207, the finance department makes a comparison between the data in the standard cost account and the data in the previous standard cost account. In step s208, if the data in the standard cost account are greatly different from the data in the previous standard cost account, then in step s210, the finance department will verify if there is a great difference between data in the standard cost account and the data in the previous standard cost account. In step s212, if the data in the financial reports are greatly different from the previous financial reports, then the data of the initial cost data of the financial report will be checked for errors. If the initial cost data has an error, then in step s214, the finance department will edit the data of the initial cost data. The editing procedures of the initial cost data by the finance department include setting the schedules of the financial cost prediction system, compiling a new financial report and re-organizing it into a new standard cost account. Otherwise, the initial cost data can be directly corrected and the corrected initial cost data can be recalculated anew. The financial department compiles the initial cost data and tranmits to the financial cost prediction system. In step s204, the finance department resets the schedules of the financial cost prediction system and compiles and organizes the financial reports into a standard cost account until the standard cost account is accurate, so that the financial cost system can be set forth.

In summary, there are several advantages to the present invention:

1. The financial cost prediction system enables the initial cost data to automatically organize into a financial report, increasing the numerical accuracy of the financial reports.

2. The finance department can set the schedules of the main server to have self-correcting financial reports.

3. it facilitates the aim of predicting future financial costs.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A financial cost prediction system, wherein the financial cost prediction system is related to compiling a plurality of initial cost data of a plurality of departments into a plurality of financial reports, further organizing the financial reports into standard cost account with an automatic and window system, the financial cost prediction system comprising:
a plurality of subservers, wherein each of the subservers corresponds to the departments and receives the initial cost data sent from the departments;
a plurality of databases, wherein each of the sub-databases corresponds to the subservers and store the initial cost data sent from the subservers;
a main server, wherein the main server is connected to the subservers, receives the initial cost data sent from the subservers, organizes the initial cost data and compiles it into financial reports, and further organizes the financial reports into a standard cost account;
a main database, wherein the main database is connected to the main server, storing the initial cost data, the financial reports and the standard cost account sent from the main server;
a finance department user terminal, wherein the finance department user terminal is connected to the main server and is used to retrieve the financial reports and standard cost account sent from the main server, as well as to edit erroneous financial reports; and
a finance department database, wherein the finance department database is connected to the user terminal and is used to store the financial reports and standard cost account sent from the finance department user terminal.

2. The financial cost prediction system as claimed in claim 1, wherein relating to the initial cost data sent from the department includes a raw wafer quantity, a raw wafer cost, a production shelf life, a production discard cost, a project-testing cost and a loaned equipment cost.

3. The financial cost prediction system as claimed in claim 1, wherein the financial reports include a wafer financial report, a period-start/period-end financial report, an END financial report, a MOVE financial report, a Yield financial report, and an Others financial report.

4. The financial cost prediction system as claimed in claim 3, wherein the period-start/period-end financial reports further include raw wafer quantity summary report, a raw wafer cost summary report and a raw wafer total cost summary report.

5. The financial cost prediction system as claimed in claim 3, wherein the period-start/period-end financial reports further include an initial production cost summary report, a production end summary report and a production shelf life detailed report.

6. The financial cost prediction system as claimed in claim 3, wherein the ENG financial reports further include a project-testing cost summary report, a loaned equipment cost report and a change of owner cost detailed report.

7. The financial cost prediction system as claimed in claim 3, wherein the MOVE financial reports further include a raw wafer quantity report, a production cost analysis report, a heavy production cost detailed report and a Daily Move Check detailed report.

8. The financial cost prediction system as claimed in claim 3, wherein the Yield financial reports further include a productivity rate difference detailed report and a production discard cost summary report.

9. The financial cost prediction system as claimed in claim 3, wherein the OTHERS financial reports further include a production volume detailed report, a production cost detailed report and a production testing transfer cost summary report.

10. The financial cost prediction system as claimed in claim 1, wherein the main database has a financial data generating zone stored in the main database where stores the initial cost data sent from the main server.

11. The financial cost prediction system as claimed in claim 10, wherein the compiling process of the main server is through setting the schedules of the main server, storing the initial cost data of the financial data generating zone and compiling it into financial reports according to the schedules of the main server.

12. The financial cost prediction system as claimed in claim 1, wherein the process whereby the main server organizes the initial cost data includes screening and classifying the initial cost data.

13. The financial cost prediction system as claimed in claim 1, wherein the processes of correcting erroneous financial reports by the finance department user terminal include correcting the errors formed in the initial cost data of erroneous financial reports, setting the schedules of the main server and compiling the financial reports anew.

14. A financial cost prediction method, wherein the financial cost prediction method is related to a method of compiling a plurality of initial cost data into a standard cost data, the method comprising:
inputting the initial cost data into the financial cost prediction system;
the financial cost prediction system organizing the initial cost data;
the financial cost prediction system editing the financial reports according to a set of schedules;
the financial cost prediction system organizing the financial reports into a standard cost account;
a finance department comparing data of a standard cost account with the data from another previous standard cost account;
if the standard cost account data and the data of another previous standard cost account are in great different, then the finance department will check for errors in the initial cost data of the financial reports;
if the data of the financial reports are greatly different from the data of another previous financial report, then the initial cost data of the financial reports and the data will be checked for errors;
if there is erroneous data in the initial cost data, then the finance department will edit the data of the initial cost data;
inputting the edited data of initial cost data to the financial cost prediction system;
setting the schedules of the financial cost prediction system, compiling and re-organizing anew the financial reports into standard cost accounts; and
performing the procedure until the standard cost accounts are accurate, so that the financial cost prediction system can be set forth.

15. The financial cost prediction method as claimed in claim 14, wherein the original cost data includes a raw wafer quantity, a raw wafer cost, a production shelf life, a production discard cost, a project-testing cost and a loaned equipment cost.

16. The financial cost prediction method as claimed in claim 14, wherein the financial reports include a wafer financial report, a period-start/period-end financial report, an END financial report, a MOVE financial report, a Yield financial report, and an Others financial report.

17. The financial cost prediction method as claimed in claim 16, wherein the financial reports further include a raw wafer quantity summary report, a raw wafer cost summary report and a raw wafer total cost summary report.

18. The financial cost prediction method as claimed in claim 16, wherein the period-start/period-end financial reports further include an initial production cost summary report, a production end cost summary report and a production shelf life detailed report.

19. The financial cost prediction method as claimed in claim 16, wherein the ENG financial reports further include a project-testing cost summary report, a loaned equipment cost summary report and a owner change cost detailed report.

20. The financial cost prediction method as claimed in claim 16, wherein the MOVE financial reports further include a production summary report, a production cost analysis report, a heavy production cost detailed report and a Daily Move Check detailed report.

21. The financial cost prediction method as claimed in claim 16, wherein the YIELD financial reports further include a productivity difference detailed report and a production discard cost summary report.

22. The financial cost prediction method as claimed in claim 16, wherein the Others financial reports include a production volume detailed report, a production cost detailed report and a production testing transfer cost summary report.

23. A financial cost prediction method as claimed in claim 14, wherein organization of the initial cost data comprises:
screening the initial cost data;
classifying the initial cost data; and
storing the screened and classified initial cost data.

24. The financial cost prediction method as claimed in claim 14, wherein the method of the figures of the initial cost data compiled by the financial department includes either setting the financial cost prediction system schedules, re-compiling the financial reports and reorganizing the standard cost account, or directly correcting the errors of the initial cost data, and re-calculating the corrected initial cost data.
